(19) United States
(12) Patent Application Publication
(10) Pub. No.: US 2011/0013342 A1
(43) Pub. Date: Jan. 20, 2011

(54) METHOD FOR PRODUCING DIELECTRIC FILM AND METHOD FOR PRODUCING CAPACITOR LAYER-FORMING MATERIAL USING THE METHOD FOR PRODUCING DIELECTRIC FILM

(75) Inventors: Yasushi Idemoto, Chiba (JP); Naoto Kitamura, Chiba (JP); Akira Ichiryu, Tokyo (JP); Naohiko Abe, Saitama (JP)

Correspondence Address: GREENBLUM & BERNSTEIN, P.L.C., 1950 ROLAND CLARKE PLACE, RESTON, VA, 20191, US

(73) Assignees: TOKYO UNIVERSITY OF SCIENCE EDUCATIONAL FOUNDATION ADMINISTRATIVE ORGANIZATION, Tokyo (JP); MITSUI MINING & SMELTING CO., LTD., Tokyo (JP)

(21) Appl. No.: 12/933,924

(22) PCT Filed: Mar. 13, 2009
(86) PCT No.: PCT/JP2009/054955

§ 371 Date: Sep. 22, 2010

(30) Foreign Application Priority Data
Mar. 25, 2008 (JP) 2008-079055
Sep. 1, 2008 (JP) 2008-224115

(51) Int. Cl. H01G 4/10; C25D 15/02

(52) U.S. Cl. 361/322; 205/109

(57) ABSTRACT

An object of the present invention is to provide a method for producing a dielectric film excellent in the deposition stability in forming a high-density dielectric film by an electrophoresis method using a dielectric particle-dispersed slurry in which dielectric particles are dispersed. In order to achieve the object, a method for producing a dielectric film using an electrophoresis method comprising arranging a cathode electrode and an anode electrode in a dielectric particle-dispersed slurry in which the dielectric particles are dispersed and carrying out electrolysis to form a dielectric film on one of the electrodes, wherein the dielectric particles contained in the dielectric particle-dispersed slurry are the calcined dielectric particles.

### TECHNICAL FIELD

The present invention relates to a method for producing a dielectric film, a method for producing a capacitor layer-forming material using the method for producing a dielectric film, a capacitor layer-forming material, and a capacitor circuit.

### BACKGROUND ART

As disclosed in Patent Document 1, a capacitor layer included in a capacitor circuit provided in the inner layer of a multilayer printed wiring board in a recent year is obtained by etching a capacitor layer-forming material having a three-layer structure of a top electrode-forming material/a dielectric layer/a bottom electrode-forming material. The dielectric layer is provided to store a certain amount of electrical charge, and various methods are employed as a method for forming the dielectric layer.

Particularly, to obtain a capacitor layer-forming material with a large area, a method employing a sol-gel method disclosed in Patent Document 4 has been used. Patent Document 2 discloses a method for producing an oxide dielectric thin film in which a substrate surface is carried out hydroxylation first and then the oxide dielectric thin film is formed on the substrate by using a metal alkoxide as a raw material. The disclosed oxide dielectric which can be formed as a thin film is a metal oxide having properties as a dielectric material, for example, LiNbO₃, Li₂B₄O₇, PbZrTiO₃, BaTiO₃, SrTiO₃, PbLaZrTiO₃, LiTaO₃, ZnO, Ta₂O₅, and the like. In addition, it is described that the oxide dielectric thin film obtained by the method is excellent in orientation and has good crystallinity.

Especially, the formation of a dielectric layer using a sol-gel method disclosed in Patent Document 2 is advantageous over the formation of a dielectric layer using a chemical vapor deposition method (CVD method) disclosed in Patent Document 3 and a sputtering deposition method disclosed in Patent Document 4 in that it is not required to use a vacuum process and it is easy to form a dielectric layer on a substrate with a large area. It is popular in the formation of a dielectric layer by the sol-gel method to use a spin coat method.

However, a capacitor layer-forming material of a large area and increased film-forming speed of a dielectric layer to improve productivity have been required in recent years. So, an electrophoresis method disclosed in Patent Document 5 has been investigated. Patent Document 5 discloses a method for producing a ferroelectric substance film having good crystal quality and a ferroelectric substance film and a producing method to provide the ferroelectric substance film obtained by the producing method comprising the steps of: electrically charged particles of a ferroelectric substance raw material; electrodepositing the electrically charged particles on a first electrode by an electrophoresis method to form a ferroelectric substance film; and heat-treating the ferroelectric substance film.

### LIST OF THE DOCUMENTS CITED

Patent Document 1: National Publication of International Patent Application 2002-539634 (WO 2000/55868)
Patent Document 2: Japanese Patent Laid-Open 07-294862
Patent Document 3: Japanese Patent Laid-Open 06-140385
Patent Document 4: Japanese Patent Laid-Open 2001-358303
Patent Document 5: Japanese Patent Laid-Open 2005-34731

### DISCLOSURE OF THE INVENTION

### Problems to be Solved of the Invention

However, the producing method disclosed in Patent Document 5 has been difficult to obtain a high-density ferroelectric substance film because the method has been poor in the stability of electrophoretic deposition in formation of a ferroelectric substance film by an electrophoresis method through electrically charged particles of an amorphous ferroelectric substance raw material followed by electrodeposition of the electrically charged particles on the electrode.

Thus, an object of the present invention is to provide a method for producing a dielectric film excellent in the deposition stability in forming a dielectric film by an electrophoresis method using a dielectric particle-dispersed slurry in which dielectric particles are dispersed.

### Means to Solve the Problem

Thus, after a devotional research, the present inventors have enabled the formation of a high-density dielectric film by the electrophoresis method according to the present invention described below and supply of a capacitor layer-forming material having good quality is enabled by the method for producing the dielectric film.

A method for producing a dielectric film: A method for producing a dielectric film according to the present invention is the method arranging a cathode electrode and an anode electrode in a dielectric particle-dispersed slurry and carrying out electrolysis to form a dielectric film on one of the electrodes, wherein calcined dielectric particles are used as the dielectric particles contained in the dielectric particle-dispersed slurry to form the dielectric film.

A method for producing a bottom electrode-forming material comprising a dielectric layer: A method for producing a bottom electrode-forming material comprising a dielectric layer according to the present invention is a method for producing a bottom electrode-forming material comprising a dielectric layer composed of two layers of [a dielectric layer]/[a bottom electrode-forming material] by using the method for producing a dielectric film described above, the method comprising the steps of:

step A: preparation of an electrode material used for the bottom electrode-forming material as an electrode material on which a dielectric film is formed;

step B: preparation of a dielectric particle-dispersed slurry by dispersing a calcined dielectric particles having an average primary particle size of 180 nm or less in a solvent; and

step C: forming of the bottom electrode-forming material comprising a dielectric layer by arranging the electrode material used as the bottom electrode-forming material and a counter electrode in the dielectric particle-dispersed slurry to provide a dielectric layer on the surface of one of the electrode materials by an electrophoresis method.

A method for producing a capacitor layer-forming material: A method for producing a capacitor layer-forming material according to the present invention is characterized in that a bottom electrode-forming material comprising a dielectric layer is prepared through the steps A to C described above, and then the top electrode-forming material is provided on the surface of the dielectric layer of the bottom electrode-forming material comprising a dielectric layer (step D) to finish a capacitor layer-forming material composed of three layers of [a top electrode-forming material]/[a dielectric layer]/[a bottom electrode-forming material].

A capacitor circuit: A capacitor circuit according to the present invention is characterized in that it is obtained by using any of the bottom electrode-forming material comprising a dielectric layer obtained by the producing method according to the present invention or the capacitor layer-forming material obtained by the producing method according to the present invention.

### Advantages of the Invention

The formation of a high-density dielectric film is enabled by using a method for producing a dielectric film according to the present invention. As a result, a high-density dielectric film can be formed on the surface of a bottom electrode-forming material with a large area, and a capacitor layer-forming material with good quality can be supplied. It also makes possible to form a dielectric film having a large area and a stable film thickness by employing proper production conditions.

### Embodiment of the Invention

Hereinafter, each embodiment of a method for producing the dielectric film according to the present invention, a method for producing a capacitor layer-forming material using the method for producing a dielectric film, a capacitor layer-forming material, and a capacitor circuit will be described.

Embodiment of producing a dielectric film: A method for producing a dielectric film according to the present invention is the method arranging a cathode electrode and an anode electrode in a dielectric particle-dispersed slurry and carrying out electrolysis to form a dielectric film on one of the electrodes. The electrophoresis method will be briefly described. Surface of the dielectric particles dispersed in the dielectric particle-dispersed slurry are positively or negatively charged to be electrically charged dielectric particles, followed by electrophoretic deposition to make them deposit on one of the electrodes to form a dielectric film. The electrophoresis method utilizes so called an electrophoresis phenomenon and it enables formation of a dielectric film with a large area in a short time.

As for the dielectric particles contained in the dielectric particle-dispersed slurry, it is preferable to use calcined dielectric particles which are secondary particles composed of agglomerated primary particles having an average primary particle size of 180 nm or less. If the average primary particle size exceeds 180 nm, the surface of the dielectric film after finishing electrophoretic deposition may be coarse, and the formation of a dielectric film having a uniform thickness may be made difficult. Note that when the agglomerated state of dielectric particles is ignored, the formation of a dielectric film provided with a smooth deposition electrodeposited surface may be more easily achieved with the decrease in the size of primary particles. The lower limit of the average primary particle size is about 5 nm. When the average primary particle size is less than 5 nm, agglomeration of particle may be severe and it may make the size control of the secondary particles obtained by agglomeration difficult to result defects in the dielectric layer formed after finishing the sintering. Further, it is more preferable to use dielectric particles having an average primary particle size of 10 nm to 30 nm. That is, the particle size of secondary particles described below can be made finer when finer primary particles are used. However, when the dielectric particles having an average primary particle size of 10 nm to 30 nm are used, secondary particles suitable for stable deposition in the electrophoresis method employed in the present invention might be prepared. Note that such secondary particle makes formation of a dielectric layer having a film thickness of 0.1 μm to 5 μm possible. It is also made possible to form a dielectric layer having a film thickness of over 0.1 μm and less than 1 μm when fine dielectric particles among them are selectively used.

Further, it is preferable that the agglomerated dielectric particles (secondary particles) which are obtained by making dielectric particles having an average primary particle size of 180 nm or less agglomerate followed by calcination and classification are used as the dielectric particles. It is preferable that the calcination is carried out at a temperature in the range of 600° C. to 1000° C.

For example, the particle size arrangement can be carried out by preparing secondary dielectric particles using a raw material powder, calcining the resulting dielectric particles, mixing the agglomerated dielectric particles with an organic solvent such as n-butanol, and then arrange the particle size of the dielectric particles by using a media mill. FIG. 1 shows an image of scanning electron microscope observation on a dielectric layer obtained by carrying out electrophoretic deposition using a dielectric particle-dispersed slurry containing well dispersed dielectric particles by calcination and particle size arrangement by using a media mill. FIG. 2 shows an image of scanning electron microscope observation on a dielectric layer obtained by carrying out electrophoretic deposition using a dielectric particle-dispersed slurry containing calcined dielectric particles just stirred and dispersed by ultrasonic vibration without particle size arrangement of the dielectric particles. In comparison between FIG. 1 and FIG. 2, it can be understood that the dielectric film formed by using the slurry with particle size arrangement (FIG. 1) contains dielectric particles having smaller and more uniform particle size than the dielectric film formed by using the slurry without particle size arrangement (FIG. 2).

Further, a remarkable difference in electrophoresis performance exists between the dielectric particle-dispersed slurries prepared after particle size arrangement, one of which uses dielectric particles with calcination and the other uses the dielectric particles without calcination. Here, streaming potential available to estimate the deposition performance of “dielectric particles with calcination” and “dielectric particles without calcination” in the electrophoresis method will be described. The streaming potential is defined as the electric potential difference generated when a fluid flow is applied to the electrical double layer in which electrical charge separation is generated by the interaction between a solid and a liquid. For example, the streaming potential of the dielectric particle-dispersed slurry having a dispersion concentration of the BST-based dielectric particles of 10.0 g/l which is prepared by mixing the slurry in which BST-based dielectric particles with a Ba/Sr ratio of 70/30 are dispersed in n-butanol with the dispersion concentration of the dielectric particles of 30 wt % and acetone can be measured by using the StabiSizer manufactured by PARTICLEMETRIX company. The obtained streaming potential is about 16 mV for the dielectric particle-dispersed slurry using the “dielectric particles without calcination”, while the streaming potential is significantly increased to 81 mV for the dielectric particle-dispersed slurry using the “dielectric particles with calcination”. That is, significantly stable deposition performance can be obtained in the case where the “dielectric particles with calcination” are used when compared with the case where the “dielectric particles without calcination” are used. Further, when the dielectric particles in the dielectric particle-dispersed slurry used in the electrophoresis method are charged positive, the resulting dielectric particles show more excellent electrophoresis performance than the dielectric particles charged negative.

Here, the reason why streaming potential is adopted even the zeta potential is popular for evaluation of electrophoresis performance will be described below. It is because that the dispersion concentration of the dielectric particles is too high not to transmit a laser beam and it made measurement with a general-purpose zeta potential analyzer difficult in the measurement of the slurry potential. However, a good correlation between zeta potential and streaming potential is confirmed. That is, particle dispersibility is better as high as the absolute values of both potentials and it results a good electrodeposited film (a film dense in morphology and good in both surface observation and cross-sectional observation) by electrophoretic deposition. In addition, correlation was confirmed in a result of verification by carrying out measurements with both a streaming potential analyzer capable of measuring without using a laser beam and an ultrasonic zeta potential analyzer.

Further, when calcination is carried out on the dielectric particles, the elution of a dielectric material component into a polar organic solvent used for a dielectric particle-dispersed slurry described below is made minimum and it reduces the fluctuation of the stoichiometry of the dielectric material. As a result, the degradation of the dielectric performance of the finished dielectric layer can also be prevented. However, when the dielectric particles are calcined at a temperature below 600° C., it is hard to reduce the fluctuation of the stoichiometry of the dielectric material constituting the dielectric particles in the organic solvent. In contrast, when the dielectric particles are calcined at a temperature over 1000° C., the surface of the dielectric film formed by an electrophoresis method may be made coarse. So, such conditions are not preferable.

In addition, the dielectric particles are preferable to have a specific surface area of 100 m²/g or less. When the specific surface area exceeds 100 m²/g, the dielectric particles may hard to be dispersed in preparation of a slurry; stability of the deposition performance of electrically charged dielectric particles may be made poor to result thickness deviation in the dielectric film formed by electrophoretic deposition. So, such condition is not preferable. More preferable specific surface area of the dielectric particles is 20 m²/g or less. The lower limit of the specific surface area is not particularly specified, but it is about 1 m²/g in the experience. The specific surface area is measured by a BET method.

Moreover, it is preferable to use perovskite-type dielectric particles as the dielectric particles described above. Especially, it is preferable to use paraelectric particles. The perovskite-type dielectric particles are those having a basic composition of barium titanate, strontium titanate, barium strontium titanate, strontium zirconate, bismuth zirconate, and the like. Especially, those having a basic composition of barium titanate, strontium titanate, and barium strontium titanate are particularly preferred. It is because electrophoresis performance is stable as the dielectric particles used in an electrophoresis method. Note that, it is clearly stated that the ratio of the A site elements (Ba, Sr) to the B site element (Ti) and oxygen (O) in the composition may be arranged in a certain range in the stoichiometric composition of (Ba₁₋ₓSrₓ)TiO₃ (0≦x≦1) for example.

Next, the reason why the perovskite-type dielectric particles of barium strontium titanate, barium titanate, strontium titanate and the like are made to be a basic composition will be described. It is because one or more selected from among manganese, silicon, nickel, aluminum, lanthanum, niobium, magnesium, and tin may made to be contained in the perovskite-type dielectric particles. These additive components can interrupt the channel for leakage current by making the additive components segregate at a grain boundary.

The dielectric film formed may be used as a dielectric layer of a capacitor layer-forming material as it is. However, it is also preferable to carry out the post-sintering. The sintering condition preferable is a sintering temperature of 700° C. to 1200° C. which makes crystallite size of the dielectric film in the (100) direction 50 nm to 200 nm when analyzed by an X-ray diffraction method. When the crystallite size in the (100) direction is 50 nm or more, the dielectric constant may increase. In contrast, when the crystallite size in the (100) direction exceeds 200 nm, it may makes extend of the service life applicable for long-term after processed into a capacitor circuit difficult. The crystallite size described is a value calculated by using the X-ray diffraction data obtained by a focusing method on the Scherrer equation. Note that the sintering temperature may be higher than the calcination temperature.

Moreover, the dielectric particles used are also preferable to be provided with a sintering aid layer on the surface. It is because that the sintering aid layer provided on the dielectric particles may promote the particle connection in the sintering of the dielectric particles. The sintering aid layer may be composed of an oxide or a hydroxide of aluminum, silicon, or germanium, or a mixture thereof. There is no special limitation in the method for forming the sintering aid layer on the surface of the dielectric particles. The method may be a wet method or an agitation coagulation method of mechanochemical mean.

Further, the sintering aid layer may be composed of any component among an aluminate-based component, a silicate-based component, and a germinate-based component or a mixed component thereof. These sintering aid layers can also be provided by a method using a metal alkoxide solution. Dielectric particles are immersed in a metal alkoxide solution containing a predetermined component followed by heating to prepare dielectric particles with a sintering aid layer. Thus, a dielectric film with fewer voids may be obtained when a dielectric film formed from the dielectric particle-dispersed slurry containing dielectric particles with a sintering aid layer is finished by heating at a temperature of about 800° C.

When dielectric particles without a sintering aid layer are used, it is preferable to use just an organic solvent as a dispersion medium to prepare a dielectric particle-dispersed slurry. As for the “organic solvent”, a ketone-based organic solvent such as acetone, methyl ethyl ketone, methyl-n-propyl ketone, methyl isopropyl ketone, diethyl ketone, acetylacetone, ethyl acetoacetate and hexanone can be used. Further, as for an alchohol-based solvent, methanol, ethanol, propanol, butanol, and the like can be used. Furthermore, as for an ether-based solvent, ethyl ether, methyl ether and the like may be used. Generally speaking, it is preferable to select and use a solvent having a high polarity as much as possible.

In contrast, when dielectric particles with the sintering aid layer are used, it is preferable to make iodine to be contained in the organic solvent constituting the dielectric particle-dispersed slurry. When the organic solvent contains iodine, the electrical charging on the surface of the dielectric particles dispersed in the organic solvent is made to be easy. The iodine concentration is preferable to be in the range of 0.05 g/l to 3.0 g/l. When the iodine concentration is less than 0.05 g/l, the electrical charging on the particle surface of the dielectric particles dispersed in the organic solvent cannot be promoted. So, it makes hard to carry out preferable electrophoretic deposition. In contrast, when the iodine concentration exceeds 3.0 g/l, the electrically charged condition may be not stable to make particle dispersibility and deposition performance poor. So, it is not preferable. As for the method for making iodine contained, there is no particular limitation, but it is preferable to use a chemical with high iodine purity. For example, a granular iodine tablet manufactured by Wako Pure Chemical Industries, Ltd. may be used after crushing. Further, the iodine concentration is more preferable to be in the range of 0.1 g/l to 0.4 g/l, and further more preferable to be in the range of 0.15 g/l to 0.35 g/l. By controlling the iodine concentration in a narrower range, the electrically charged state at the surface of the dielectric particles dispersed in the organic solvent may be made stabile, and the particle dispersibility and deposition performance of the dielectric particles in the organic solvent are well balanced, thus significantly improving electrophoretic deposition stability.

Further, there is no particular limitation in the dispersion concentration of the dielectric particles contained in the dielectric particle-dispersed slurry. However, it is preferable to make dispersion concentration of the dielectric particles in the range of 0.2 g/l to 20 g/l to stabilize the electrophoresis performance. When the dispersion concentration of the dielectric particles is less than 0.2 g/l, the formation rate of a dielectric film may be slow not to satisfy the industrial productivity. In contrast, when the dispersion concentration of the dielectric particles exceeds 20 g/l, the dispersion concentration of the dielectric particles may be excessive to obstruct formation of a dielectric film with a smooth surface. So, it is not preferable. It is more preferable that the dielectric particles are contained in a dispersion concentration of the dielectric particles of 5 g/l to 15 g/l. It is because a dielectric film can be formed at an industrially required rate and a dielectric film with a smooth surface is easily formed with stability even when there are some fluctuations in other operation conditions.

Further, in order to make agglomerated dielectric particles disagglomerate in preparation of the dielectric particle-dispersed slurry, it is preferable to make the agglomerated dielectric particles disagglomerate by making the dielectric particles, media, and optionally a dispersant disperse in the organic solvent followed by mechanically agitating the mixture. In such processes, not to destroy preferable agglomerated state of the agglomerated dielectric components in the agglomerated dielectric particles, it is preferable to make the dielectric particles disagglomerate mechanically by carrying out medium grinding using zirconia beads (a diameter of 2 mm) to the dielectric particle-dispersed slurry. As for the dispersant in such a case, silicon-based dispersant can be recommended.

Embodiment of producing a capacitor layer-forming material: A method for producing a capacitor layer-forming material according to the present invention is a method for producing a capacitor layer-forming material composed of three layers of [a top electrode-forming material]/[a dielectric layer]/[a bottom electrode-forming material] by using the method for producing a dielectric film described above, and comprises the steps A to D below.

In step A, an electrode material to constitute a bottom electrode-forming material is prepared as an electrode material on which a dielectric film is formed. The electrode material could be provided with a plane surface or a surface with certain unevenness, or could be a three-dimensional structure. The electrode on which a dielectric film is formed is made to constitute a bottom electrode-forming material in producing of a capacitor layer-forming material. So, any of copper, nickel, a copper alloy, and a nickel alloy or a clad material thereof can be used as a material suitable for the bottom electrode-forming material. In addition, the concept of the electrode material includes a metal foil. It is because preferable thickness of the bottom electrode-forming material of the capacitor layer-forming material is 1 μm to 200 μm, particularly 10 μm to 100 μm. When the thickness is less than 1 μm, handlability of the layer as a capacitor circuit-forming material is made poor to lose reliability as an electrode when a capacitor circuit is formed. In contrast, practical demand on the thickness exceeding 100 μm may never exist. Further, when the thickness of the bottom electrode-forming material is less than 10 μm, handling as a foil may be difficult. So, as for a metal foil, it is preferable to use a metal foil with a carrier foil in which the metal foil and the carrier foil are bonded together via a bonding interface. The carrier foil in such a case may be released in any step after the capacitor circuit-forming material described in the present invention is formed.

Note that when a metal foil is used for the bottom electrode-forming material, it is preferable to use a metal foil with a surface roughness as low as possible. Even when the surface of the metal foil is provided with some bumps, the electrophoresis method used in the present invention can make the film thickness uniform and the surface of the formed dielectric film may be made smooth. However, the more smooth the surface of the metal foil used as the bottom electrode-forming material is, the film thickness uniformity and the smoothness of the surface of the dielectric film formed thereon may be made excellent. So, when a metal foil with high surface roughness must be used, it is preferable to make the metal foil surface smooth by chemical polishing, physical polishing, or the like.

The metal foil includes all kinds of the foil produced by a rolling method, an electro-deposition method, or the like. In addition, composite clad foil composed of a metal foil and a layer of copper, a copper alloy, nickel, or a nickel alloy clad on the metal foil as the outermost layer may also be included. For example, a composite clad foil comprising a copper foil provided with a nickel layer or a nickel alloy layer on the surface of the copper foil can be used as an electrode (bottom electrode-forming material) on which a dielectric film is formed. However, the bottom electrode-forming material is preferably a metal layer of a single component. Because the bottom electrode-forming material is a relatively thick layer, when the single component layer structure is applied, it may make the etching rate constant in forming of a bottom electrode circuit by an etching method and makes forming of a fine capacitor circuit easy.

It is preferable to constitute a bottom electrode-forming material from copper or a copper alloy (brass composition, a Corson alloy composition, and the like) to make the capacitor circuit formability of the bottom electrode-forming material excellent to finish a fine capacitor circuit. It is because that copper and copper alloy is the material suitable for fine etching. In contrast, it is preferable to constitute a bottom electrode-forming material from nickel or a nickel alloy (a nickel-phosphorus alloy composition, a nickel-cobalt alloy composition, and the like) when increasing of the strength in high temperatures of the capacitor circuit made of the bottom electrode-forming material is first priority to improve the heat resistance against to the thermal history in the production process.

In step B, calcined dielectric particles having an average primary particle size of 180 nm or less are made to be dispersed in an organic solvent to obtain a dielectric particle-dispersed slurry. The prepared dielectric particle-dispersed slurry may be carried out electrophoretic deposition after adding iodine to the dielectric particle-dispersed slurry composed of an organic solvent and the dielectric particles. Note that there is no particular limitation on the mixing method of iodine in this procedure. Further, in order to disagglomerate the dielectric particles in the agglomerated state to be disagglomerated dielectric particles, it is preferable to use a bead mill using media, a fluid mill, and the like.

In step C, a cathode electrode and an anode electrode are arranged in the dielectric particle-dispersed slurry to form a dielectric film on the surface of one of the electrode materials by an electrophoresis method to obtain a bottom electrode-forming material comprising a dielectric film. In this step, electrophoretic deposition is carried out to form a dielectric film by making any one the cathode electrode and the anode electrode be the electrode on which a dielectric film is formed, and the other electrode is made to be the electrode on which a dielectric film is not formed.

It is preferable to use an electrode composed of a component selected from stainless steel, titanium, and an insoluble anode material as the electrode on which a dielectric film is not formed. It is because that in the combination with the material of the electrode on which a dielectric film is formed, a polarization characteristic suitable for the electrophoresis method according to the present invention is provided and good performance in terms of durability can be achieved. There is no particular limitation on the shape thereof.

Next, although there is no strict limitation of conditions for the method for producing a dielectric film according to the present invention, it is preferable to carry out electrophoretic deposition by employing the following conditions from the viewpoint of operation stability. It is preferable to carry out electrolysis by arranging the electrode gap between the cathode electrode and the anode electrode to be 0.5 cm to 20 cm, applying voltage of 2 V to 200 V, more preferably 50 V to 200 V to form a dielectric film on one of the electrodes. When the electrode gap is less than 1 cm, the electrode gap may be too close to make electrical charge of the dielectric particle-dispersed slurry between the electrodes insufficient to result unstable electrophoretic deposition. In contrast, when the electrode gap exceeds 20 cm, the gap between the electrodes may be too far to make deposition of the dielectric particles to the electrode on which the dielectric film is formed not uniform and hardly obtain a dielectric film having a preferable film thickness, and the voltage applied between the electrodes should be increased to lose economic advantage. As described above, the voltage of 2 V to 200 V is applied when an electrode gap is 0.5 cm to 20 cm. When the applied voltage is less than 2 V, the deposition rate may be too slow not to satisfy the productivity required in industrial production. In contrast, when the applied voltage exceeds 200 V, the deposition rate may be too fast to make a film thickness of the dielectric film formed not uniform. So, it is not preferable.

Then, after step C, it is also preferable to sinter the bottom electrode-forming material comprising a dielectric film if required. More specifically, the material is heated at a temperature of 700° C. to 1200° C. for sintering, and the dielectric layer after sintering is adjusted to comprise a crystallite size in the (100) direction analyzed by an X-ray diffraction method of 50 nm to 200 nm. So, with respect to the sintering conditions, any condition may be employed as long as the crystallite size in the (100) direction is made to be 50 nm or more as a results. FIG. 3 shows the cross sectional image of the dielectric layer after sintering followed by providing of a top electrode-forming material in step D. FIG. 4 shows the cross sectional image of the dielectric layer before sintering. In comparison between FIG. 3 and FIG. 4, it can be understood that the connection states of the dielectric particles are clearly different.

In step D, the top electrode-forming material is provided on the surface of the dielectric layer of the bottom electrode-forming material comprising a dielectric layer to form the capacitor layer-forming material composed of three layers of [a top electrode-forming material]/[a dielectric layer]/[a bottom electrode-forming material]. The top electrode-forming material is preferable to be constituted with copper, nickel, a copper alloy, or a nickel alloy. As the top electrode-forming material, copper or a copper alloy is preferable to be used when first priority is etching processability, and nickel or a nickel alloy is preferable to be used when first priority is mechanical strength. The metal layer constituting the top electrode-forming material preferably has a thickness of 1 μm to 100 μm. When the thickness of the metal layer is less than 1 μm, the layer may have a poor strength, which is not preferable because the greatest care is required for handling, and deformation may be caused by the pressure in the hot-pressing for finishing a multilayered printed-wiring board. In contrast, the thickness of the metal layer exceeds 100 μm may make fine processing of the top electrode by an etching method difficult to result poor shape in the top electrode circuit formed. So, it is not preferable.

The capacitor layer-forming material obtained has a significantly high-density dielectric film among the dielectric films formed by the electrophoresis method as a dielectric layer. The capacitor layer-forming material is suitable for producing a product having the dielectric properties, an average capacitance density of 20 nF/cm² to 220 nF/cm² and a relative dielectric constant of 20 to 1,000.

### EXAMPLES

### Example 1

In the example 1, a capacitor layer-forming material composed of three layers of [a top electrode-forming material]/[a dielectric layer]/[a bottom electrode-forming material] was prepared through the following steps.

Step A: A nickel foil having an average thickness of 50 μm produced by a rolling method used for a bottom electrode-forming material was prepared as an electrode material (cathode electrode) on which a dielectric film should be formed. Note that the average thickness of the nickel foil produced by a rolling method is the gage thickness.

Step B: (Ba_{0.9}Sr_{0.1})TiO₃ particles having an average primary particle size of 20 nm were made to be agglomerated and calcined at a temperature of 850° C. followed by particle size arrangement to obtain the (Ba_{0.9}Sr_{0.1})TiO₃ particles having an average secondary particle size of about 80 nm and a specific surface area of 18.38 m²/g. Then, the prepared dielectric particles were dispersed in n-butanol to constitute the slurry, then acetone as an organic solvent was mixed to arrange a dispersion concentration of the dielectric particles of 10 g/l followed by stirring using ultrasonic vibration for 5 min. to finish a dielectric particle-dispersed slurry.

Step C: An electrode material (cathode electrode) on which a dielectric film should be formed and a stainless steel plate (anode electrode) were arranged with electrode gap of 15 mm in the dielectric particle-dispersed slurry. A bottom electrode-forming material comprising a dielectric film was prepared in the manner that dielectric film of (Ba_{0.9}Sr_{0.1})TiO₃ was formed on the electrode material (cathode electrode) on which a dielectric film should be formed by applying the voltage of 80 V for 4 seconds. The bottom electrode-forming material comprising a dielectric film was heated up to 1,000° C. with a temperature elevation rate of 5° C./sec. and was kept at 1,000° C. for 15 min in a nitrogen-gas substituted atmosphere to sinter the material to make the crystallite size in the (100) direction to be 54.0 nm. Note that the crystal orientation was determined on the basis of the reference data of PDF No. 05-0626.

Step D: Then, a metal mask was provided on the surface of the dielectric layer of the bottom electrode-forming material comprising a dielectric film and a copper layer having a thickness of 0.2 μm was formed as a top electrode-forming material on the surface of the dielectric layer of the bottom electrode-forming material comprising a dielectric film by a sputtering deposition method to finish a capacitor layer-forming material composed of three layers of [a top electrode-forming material]/[a dielectric layer]/[a bottom electrode-forming material] (the state corresponds to FIG. 3).

Dielectric properties were evaluated on the capacitor layer-forming material composed of three layers. Thickness of the dielectric layer obtained was 2.6 μm. In the measurement on an electrode size of 1 mm×1 mm, average capacitance density was 162 nF/cm²; the relative dielectric constant was 456; Tan δ was 0.034; and the leakage current density at 10 V was 3.9×10⁻⁸ A/cm².

### Example 2

In the example 2, a bottom electrode-forming material comprising a dielectric layer composed of two layers of [a dielectric layer]/[a bottom electrode-forming material] was prepared through the steps described below.

Step A: A nickel foil having an average thickness of 50 μm produced by a rolling method used for a bottom electrode-forming material was prepared as an electrode material (cathode electrode) on which a dielectric film should be formed. Note that the average thickness of the nickel foil produced by a rolling method is the gage thickness.

Step B: (Ba_{0.7}Sr_{0.3})TiO₃ particles having an average primary particle size of 20 nm were made to be agglomerated and calcined at a temperature of 850° C. followed by particle size arrangement to obtain the (Ba_{0.7}Sr_{0.3})TiO₃ particles having an average secondary particle size of about 80 nm and a specific surface area of 15.42 m²/g. Then, the surface of the (Ba_{0.7}Sr_{0.3})TiO₃ particles was coated with an aluminum-based sintering aid to obtain an aluminum-based sintering aid coated (Ba_{0.7}Sr_{0.3})TiO₃ particles having a specific surface area of 15.42 m²/g and were dispersed in n-butanol to constitute a slurry, then acetone as an organic solvent was mixed to arrange a dispersion concentration of the dielectric particles of 7.5 g/l, iodine was made to contained at a concentration of 0.3 g/l, followed by stirring by using ultrasonic vibration for 5 min to finish a dielectric particle-dispersed slurry. The amount of the aluminum component fixed to the aluminum-based sintering aid coated (Ba_{0.7}Sr_{0.3})TiO₃ particles was 1.32 wt % in terms of Al₂O₃.

Step C: An electrode material (cathode electrode) on which a dielectric film should be formed and a stainless steel plate. (anode electrode) were arranged with electrode gap of 15 mm in the dielectric particle-dispersed slurry. A bottom electrode-forming material comprising a dielectric film was prepared in the manner that dielectric film of (Ba_{0.7}Sr_{0.3})TiO₃ was formed on the electrode material (cathode electrode) on which a dielectric film should be formed by applying the voltage of 120 V for 2 seconds. Then, the bottom electrode-forming material comprising a dielectric film was heated up to 800° C. with a temperature elevation rate of 10° C./sec. and was kept at 800° C. for 15 min in an air atmosphere. Thickness of the obtained dielectric layer was 2.2 μm. Cross sectional image of the dielectric layer of the bottom electrode-forming material comprising a dielectric film is shown in FIG. 5.

### Example 3

In the example 3, a capacitor layer-forming material composed of three layers of [a top electrode-forming material]/[a dielectric layer]/[a bottom electrode-forming material] was prepared through the following steps.

Step A: A nickel foil having an average thickness of 50 μm produced by a rolling method used for a bottom electrode-forming material was prepared as an electrode material (cathode electrode) on which a dielectric film should be formed. Note that the average thickness of the nickel foil produced by a rolling method is the gage thickness.

Step B: (Ba_{0.9}Sr_{0.1})TiO₃ particles having an average primary particle size of 5 nm were made to be agglomerated and calcined at a temperature of 850° C. followed by particle size arrangement to obtain the (Ba_{0.9}Sr_{0.1})TiO₃ particles having an average secondary particle size of about 20 nm and a specific surface area of 61.26 m²/g. Then, the (Ba_{0.9}Sr_{0.1})TiO₃ particles were dispersed in n-butanol to constitute a slurry, then acetone as an organic solvent was mixed to arrange dispersion concentration of the dielectric particles of 15 g/l, iodine was made to contained at a concentration of 0.2 g/l, followed by stirring by using ultrasonic vibration for 5 min to finish a dielectric particle-dispersed slurry.

Step C: An electrode material (cathode electrode) on which a dielectric film should be formed and a stainless steel plate (anode electrode) were arranged with electrode gap of 15 mm in the dielectric particle-dispersed slurry. A bottom electrode-forming material comprising a dielectric film was formed in the manner that dielectric film of (Ba_{0.9}Sr_{0.1})TiO₃ was formed on the electrode material (cathode electrode) on which a dielectric film should be formed by applying the voltage of 80 V for 4 seconds. Then, the bottom electrode-forming material comprising a dielectric film was heated to 800° C. with a temperature elevation rate of 5° C./sec. and was kept at 800° C. for 30 min in a nitrogen-gas substituted atmosphere.

Step D: Then, a metal mask was provided on the surface of the dielectric layer of the bottom electrode-forming material comprising a dielectric film and a copper layer having a thickness of 0.2 μm was formed as a top electrode-forming material on the dielectric layer of the bottom electrode-forming material comprising a dielectric film by a sputtering deposition method to finish a capacitor layer-forming material composed of three layers of [a top electrode-forming material]/[a dielectric layer]/[a bottom electrode-forming material].

Dielectric properties were evaluated on the capacitor layer-forming material composed of three layers. The dielectric layer obtained had a thickness of 0.7 μm. The average capacitance density was 79.4 nF/cm²; the relative dielectric constant was 62.2; Tan δ was 0.063; and the leakage current density at 10 V was 1.6×10⁻⁶ A/cm² when measured with an electrode size of 1 mm×1 mm.

### Comparative Example

In the comparative example, the agglomerated dielectric particles used in Example 1 were replaced to the secondary particles without calcination prepared by agglomerating (Ba_{0.9}Sr_{0.1})TiO₃ particles having an average primary particle size of 20 nm. The secondary particles without calcination were the (Ba_{0.9}Sr_{0.1})TiO₃ particles having an average secondary particle size of about 80 nm and a specific surface area of 20.27 m²/g. Other steps are substantially the same as in Example 1.

In the comparative example, even the capacitor layer-forming material as same with the example 1 was tried to prepare, but film thickness of the obtained dielectric layer was not uniform, film includes plenty of defects and the bottom electrode-forming material is exposed. That is, sufficient dielectric properties could not be evaluated.

### Comparison Among Examples and Comparative Example

In the comparative example, the film-forming rate was slow and the adhesion of the dielectric layer to the bottom electrode-forming material was poor to cause plenty of defects in the dielectric film to expose the surface of the bottom electrode-forming material. In contrast, in the examples, the film-forming rates were high, the film thicknesses were uniform, the adhesions of the dielectric layers to the bottom electrode-forming materials were excellent and the defect of the dielectric film exposing the surface of the bottom electrode-forming material were not observed in the dielectric films and a dielectric films in high-density were obtained.

### INDUSTRIAL APPLICABILITY

The method for producing a dielectric film according to the present invention makes formation of a high-density dielectric film possible. As a result, a high-density dielectric film can be formed on the surface of a bottom electrode-forming material with a large area, and the mass-production performance of a capacitor layer-forming material with good quality is greatly improved.

### BRIEF DESCRIPTION OF THE DRAWINGS

FIG. 1 is an image of scanning electron microscope observation on a dielectric layer obtained by carrying out electrophoretic deposition using a dielectric particle-dispersed slurry containing well dispersed dielectric particles by calcination and particle size arrangement by using a media mill.

FIG. 2 is an image of scanning electron microscope observation on a dielectric layer obtained by carrying out electrophoretic deposition using a dielectric particle-dispersed slurry containing dielectric particles just stirred and dispersed by ultrasonic vibration without calcination and particle size arrangement of the dielectric particles.

FIG. 3 is a cross-sectional image of the dielectric layer after sintering followed by providing of a top electrode-forming material.

FIG. 4 is a cross-sectional image of the dielectric layer before sintering.

FIG. 5 is a cross-sectional image of the dielectric layer composed of (Ba_{0.7}Sr_{0.3})TiO₃ particles coated with an aluminum-based sintering aid.

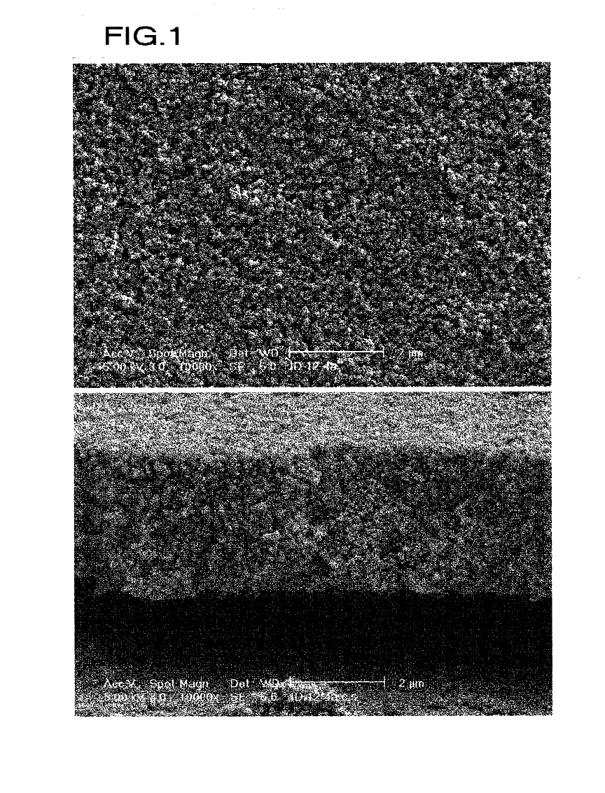

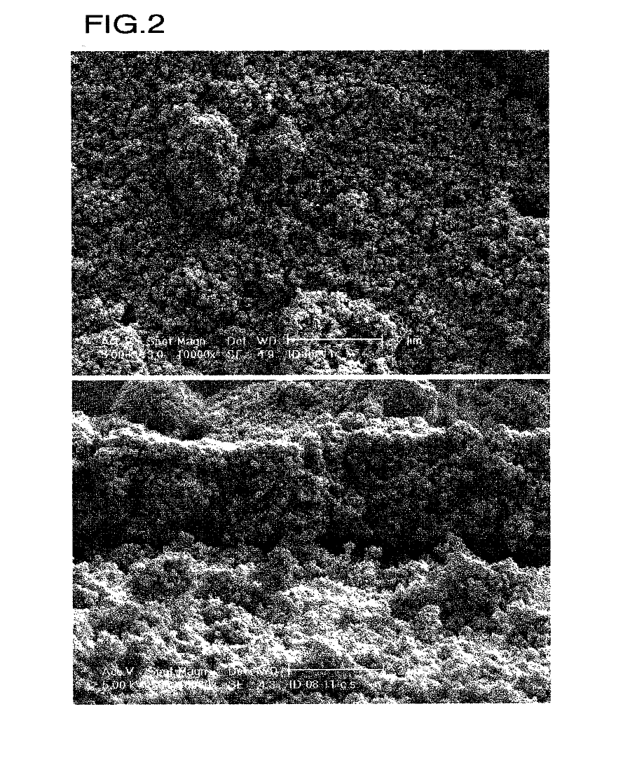

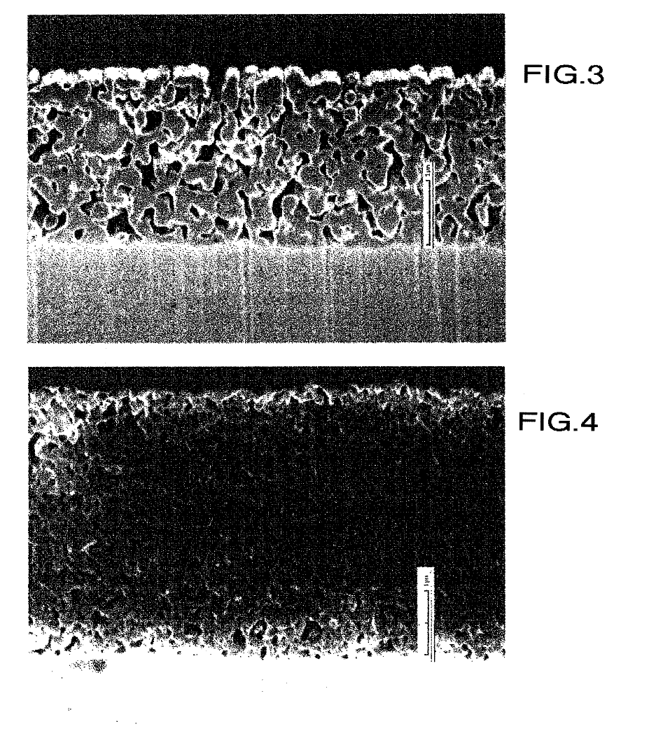

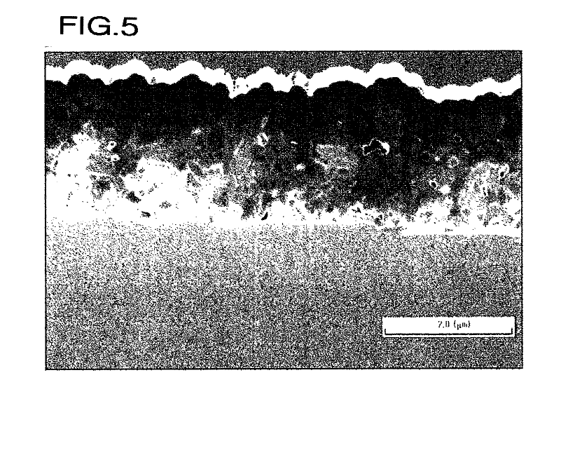

1. A method for producing a dielectric film by arranging a cathode electrode and an anode electrode in a dielectric particle-dispersed slurry and carrying out electrolysis to form a dielectric film on one of the electrodes, wherein calcined dielectric particles are used as the dielectric particles contained in the dielectric particle-dispersed slurry to form the dielectric film.

2. The method for producing a dielectric film according to claim 1, wherein a secondary particle which is an agglomerated primary particle having an average primary particle size of 180 nm or less are used as the dielectric particles.

3. The method for producing a dielectric film according to claim 1, wherein the dielectric powder constituted with the dielectric particles has powder property, a specific surface area of 100 m²/g or less.

4. The method for producing a dielectric film according to claim 1, wherein the dielectric particles are paraelectric particles.

5. The method for producing a dielectric film according to claim 1, wherein the dielectric particles have a basic composition of barium titanate, strontium titanate and barium strontium titanate.

6. The method for producing a dielectric film according to claim 1, wherein the calcination of the dielectric particles is heat-treating at a temperature of 600° C. to 1000° C.

7. The method for producing a dielectric film according to claim 1, wherein when the dielectric film after heated at a temperature of 700° C. to 1200° C. is analyzed by an X-ray diffraction method, the dielectric film has a structure in which the crystallite size in the (100) direction is 50 nm to 200 nm.

8. The method for producing a dielectric film according to claim 1, wherein the dielectric particles used are provided with a sintering aid layer on the surface of the dielectric particles.

9. A method for producing a bottom electrode-forming material comprising a dielectric layer composed of two layers of [a dielectric layer]/[a bottom electrode-forming material] by using the method for producing a dielectric film according to claim 1, the method comprising the steps of:
step A: preparation of an electrode material used for the bottom electrode-forming material as an electrode material on which a dielectric film is formed;
step B: preparation of a dielectric particle-dispersed slurry by dispersing calcined dielectric particles having an average primary particle size of 180 nm or less in a solvent; and
step C: forming of the bottom electrode-forming material comprising a dielectric layer by arranging the electrode material used for the bottom electrode-forming material and a counter electrode in the dielectric particle-dispersed slurry to provide a dielectric layer on the surface of one of the electrode materials by an electrophoresis method.

10. The method for producing a bottom electrode-forming material comprising a dielectric layer according to claim 9, a sintering step for heating to sinter the bottom electrode-forming material comprising a dielectric layer is provided after the step C.

11. A method for producing a capacitor layer-forming material composed of three layers of [a top electrode-forming material]/[a dielectric layer]/[a bottom electrode-forming material], the method comprising:
forming of a bottom electrode-forming material comprising a dielectric layer through the steps according to claim 9; and then
(step D) the top electrode-forming material is provided on the surface of the dielectric layer of the bottom electrode-forming material comprising a dielectric layer to form the capacitor layer-forming material composed of three layers of [a top electrode-forming material]/[a dielectric layer]/[a bottom electrode-forming material].

12. A capacitor circuit obtained by using the bottom electrode-forming material comprising a dielectric layer obtained by the producing method according to claim 9.

13. A capacitor circuit obtained by using the capacitor layer-forming material obtained by the producing method according to claim 11.
